(19) United States
(12) Patent Application Publication
(10) Pub. No.: US 2008/0160372 A1
(43) Pub. Date: Jul. 3, 2008

(54) Piping Structure of a Fuel Cell Stack

(75) Inventor: Takeshi Shiomi, Yokohama-shi (JP)

Correspondence Address: YOUNG & BASILE, P.C., 3001 WEST BIG BEAVER ROAD, SUITE 624, TROY, MI, 48084, US

(73) Assignee: NISSAN MOTOR CO., LTD., Yokohama-shi, Kanagawa (JP)

(21) Appl. No.: 11/815,058

(22) PCT Filed: Feb. 15, 2006
(86) PCT No.: PCT/IB2006/000299

§ 371 Date: Jul. 30, 2007

(30) Foreign Application Priority Data
Feb. 18, 2005 (JP) 2005-043119

(51) Int. Cl. H01M 8/02; F28D 15/00

(52) U.S. Cl. 429/26; 29/890.03

(57) ABSTRACT

The invention is directed to a piping structure of a fuel cell stack that discharges gas from a coolant fluid outlet pipe before the gas accumulates in a coolant fluid passage within the fuel cell stack. In addition, the piping structure drains fluid from a fuel gas outlet pipe and an oxidant gas outlet pipe before the fluid accumulates in a fuel gas passage and an oxidant gas passage, respectively, within the fuel cell stack. In this way, the piping structure described herein improves cooling performance of the coolant fluid as well as power generation performance and life of the fuel cell stack.

This application claims priority from Japanese Patent Application No. 2005-043119, filed Feb. 18, 2005, the entire contents of which is incorporated herein by reference.

### TECHNICAL FIELD

The invention relates to a piping structure of a fuel cell stack.

### BACKGROUND

A solid polyelectrolyte-type fuel cell contains a membrane electrode assembly comprising an electrolyte membrane that includes an ion-exchange membrane, a fuel electrode placed on a surface of the electrolyte membrane, and an air electrode placed on another surface of the electrolyte membrane. A unit fuel cell may be formed by installing a separator, which serves as a passage for supplying fuel gas and oxidant gas, respectively, to the fuel electrode and the air electrode of the membrane electrode assembly. Since a unit fuel cell generates less than approximately 1 V (volt), several unit fuel cells may be layered to form a fuel cell stack. The fuel cell stack may then be installed within a device, such as a vehicle, to provide power to the device.

In a unit fuel cell, a reaction occurs on a fuel electrode side, in which hydrogen converts into hydrogen ions and electrons (H₂→2H⁺+2e⁻), and a reaction occurs on an air electrode side, in which water is generated by supplying oxygen to hydrogen ions permeating the electrolyte membrane and electrons circulating in the external circuit (2H⁺+2e⁻+(½)O₂→H₂O). In order for these reactions to be appropriately completed, the hydrogen ions are humidified in order to pass through the electrolyte membrane to the air electrode side of the fuel cell. In addition, the generated water must be drained out of gas passages within the fuel cell and, specifically, out of an oxidant gas passage so as not to inhibit the supply of oxidant gas to the air electrode. Furthermore, in order to effectively cool the fuel cell from heat derived during the reaction in the air electrode, air must not accumulate in a coolant fluid passage within the fuel cell.

Conventionally, a coolant fluid pipe outlet is positioned above a level of a penetration manifold of the fuel cell to improve ventilation ability within the coolant fluid pipe. In addition, pipe outlet positions for oxidant gas and fuel gas are positioned lower than the penetration manifold in order to improve drainability. However, this technology merely specifies the position of a connector for each fluid with the penetration manifold of the fuel cell stack. Therefore, air may accumulate in the coolant fluid passage within the fuel cell stack, which may lead to deterioration of breathability and cooling performance within the fuel cell stack.

### SUMMARY

In general, the invention is directed to a piping structure of a fuel cell stack that discharges gas from a coolant fluid outlet pipe before the gas accumulates in a coolant fluid passage within the fuel cell stack. In addition, the piping structure drains fluid from a fuel gas outlet pipe and an oxidant gas outlet pipe before the fluid accumulates in a fuel gas passage and an oxidant gas passage, respectively, within the fuel cell stack. In this way, the piping structure described herein improves cooling performance of the coolant fluid as well as power generation performance and life of the fuel cell stack.

For example, the piping structure includes a coolant fluid outlet connector positioned on a manifold of the fuel cell stack that connects a coolant fluid passage within the fuel cell stack and a coolant fluid outlet pipe that drains a coolant fluid from the coolant fluid passage. The coolant fluid outlet connector is positioned on the manifold of the fuel cell stack above a level of the coolant fluid passage within the fuel cell stack to enable gas to be discharged from the coolant fluid outlet pipe. In this way, the coolant fluid outlet pipe may discharge gas from the coolant fluid passage while draining the coolant fluid from the coolant fluid passage that maintains an upward flow of the coolant fluid.

In addition, the piping structure includes inlet connectors and outlet connectors for each of the coolant fluid, the oxidant gas, and the fuel gas. The inlet and outlet connectors are positioned on the manifold of the fuel cell stack such that each of the connectors is not positioned directly above or below another one of the connectors. In this way, the piping structure enables various sensors to be installed within inlet pipes and outlet pipes substantially adjacent to the inlet connectors and the outlet connectors, respectively, of the fuel cell stack.

In one embodiment, the invention is directed to a piping structure of a fuel cell stack comprising a coolant fluid inlet connector and a coolant fluid outlet connector positioned on a manifold of the fuel cell stack, and a coolant fluid passage within the fuel cell stack that connects to the coolant fluid inlet connector and the coolant fluid outlet connector. The piping structure also comprises a coolant fluid inlet pipe that connects to the coolant fluid inlet connector to supply a coolant fluid to the coolant fluid passage, and a coolant fluid outlet pipe that connects to the coolant fluid outlet connector to drain the coolant fluid from the coolant fluid passage. The coolant fluid outlet connector is positioned on the manifold of the fuel cell stack above a level of the coolant fluid passage within the fuel cell stack to enable gas to be discharged from the coolant fluid outlet pipe.

In another embodiment, the invention is directed to a method of manufacturing a piping structure of a fuel cell stack comprising positioning a coolant fluid inlet connector and a coolant fluid outlet connector on a manifold of the fuel cell stack, and connecting a coolant fluid passage within the fuel cell stack to the coolant fluid inlet connector and the coolant fluid outlet connector. The method also comprises connecting a coolant fluid inlet pipe to the coolant fluid inlet connector to supply a coolant fluid to the coolant fluid passage, and connecting a coolant fluid outlet pipe to the coolant fluid outlet connector to drain the coolant fluid from the coolant fluid passage. The method further includes positioning the coolant fluid outlet connector on the manifold of the fuel cell stack above a level of the coolant fluid passage within the fuel cell stack to enable gas to be discharged from the coolant fluid outlet pipe.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a perspective view illustrating a piping structure of a fuel cell stack in accordance with an embodiment of the invention.

FIG. 2 is a perspective view illustrating a coolant fluid flow through the piping structure of the fuel cell stack from FIG. 1.

FIG. 3 is a cross-sectional view illustrating a coolant fluid flow through a unit fuel cell within the fuel cell stack from FIG. 1.

FIG. 4 is a perspective view illustrating an oxidant gas flow through the piping structure of the fuel cell stack from FIG. 1.

FIG. 5 is a cross-sectional view illustrating an oxidant gas flow through a unit fuel cell within the fuel cell stack from FIG. 1.

FIG. 6 is a perspective view illustrating a fuel gas flow through the piping structure of the fuel cell stack from FIG. 1.

FIG. 7 is a cross-sectional view illustrating a fuel gas flow through a unit fuel cell within the fuel cell stack from FIG. 1.

FIG. 8 is a perspective view illustrating a piping structure of a set of fuel cell stacks in accordance with another embodiment of the invention.

FIG. 9 is a perspective view illustrating a coolant fluid flow through the piping structure of the set of fuel cell stacks from FIG. 8.

FIG. 10 is a cross-sectional view illustrating a coolant fluid flow through a unit fuel cell within each of the set of fuel cell stacks from FIG. 8.

FIG. 11 is a perspective view illustrating an oxidant gas flow through the piping structure of the set of fuel cell stacks from FIG. 8.

FIG. 12 is a cross-sectional view illustrating an oxidant gas flow through a unit fuel cell within each of the set of fuel cell stacks from FIG. 8.

FIG. 13 is a perspective view illustrating a fuel gas flow through the piping structure of the set of fuel cell stacks from FIG. 8.

FIG. 14 is a cross-sectional view illustrating a fuel gas flow through a unit fuel cell within each of the set of fuel cell stacks from FIG. 8.

FIG. 15 is a perspective view illustrating a piping structure of a fuel cell stack in accordance with a further embodiment of the invention.

### DETAILED DESCRIPTION

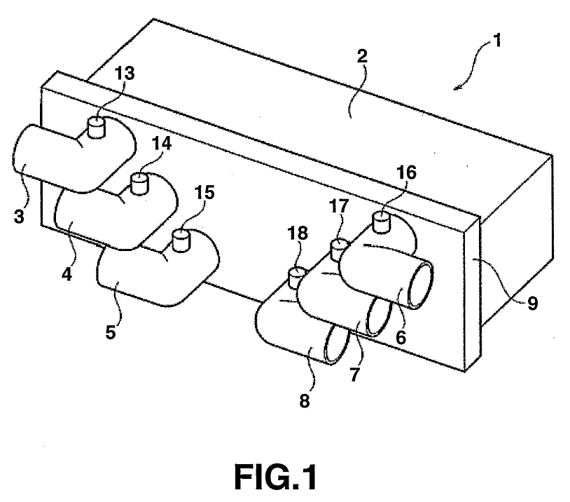

FIG. 1 is a perspective view illustrating a piping structure 1 of a fuel cell stack 2 in accordance with an embodiment of the invention. As shown in FIG. 1, piping structure 1 includes a fuel cell stack 2 that generates power by an electrochemical reaction between a fuel gas and an oxidant gas, a plurality of inlet and outlet pipes 3-8, a manifold 9 of fuel cell stack 2 that connects each of pipes 3-8 to fuel cell stack 2, and sensors 13-18 installed within pipes 3-8. Manifold 9 of fuel cell stack 2 connects to each of pipes 3-8 for fuel gas, oxidant gas, and coolant fluid, to supply each of the fluids to fuel cell stack 2 and discharge each of the fluids from fuel cell stack 2.

Fuel cell stack 2 may be formed by horizontally layering several unit fuel cells. Fuel cell stack 2 generates power by supplying a fuel gas, e.g., hydrogen gas, to an anode of each unit fuel cell within fuel cell stack 2, and supplying an oxidant gas and air to a cathode of each unit fuel cell within fuel cell stack 2. The fuel gas and the oxidant gas cause an electrochemical reaction in an electrolyte membrane between the anode and the cathode of each unit fuel cell within fuel cell stack 2. In addition, each unit fuel cell within fuel cell stack 2 includes a coolant fluid passage for cooling the unit fuel cell, which may become heated during the electro-chemical reaction.

A coolant fluid inlet pipe 4 supplies a coolant fluid to fuel cell stack 2 and a coolant fluid outlet pipe 6 that drains the coolant fluid from fuel cell stack 2. An oxidant gas inlet pipe 3 supplies the oxidant gas to fuel cell stack 2 and an oxidant gas outlet pipe 8 discharges the oxidant gas from fuel cell stack 2. A fuel gas outlet pipe 5 discharges a fuel gas from fuel cell stack 2 and a fuel gas inlet pipe 7 supplies the fuel gas to fuel cell stack 2. As shown in FIG. 1, each of inlet pipes 3, 4, and 7 are positioned on an opposite side of manifold 9 of fuel cell stack 2 as their respective outlet pipes 5, 6, and 8. Furthermore, coolant fluid outlet pipe 6 and oxidant gas outlet pipe 8 are positioned on the same side of manifold 9 and fuel gas outlet pipe 5 is positioned on the other side of manifold 19.

In the illustrated embodiment, oxidant gas inlet pipe 3 is connected to an upper level portion on a first side of manifold 9 of fuel cell stack 2. Coolant fluid inlet pipe 4 is connected to a middle level portion on the first side of manifold 9 of fuel cell stack 6 such that it does not overlap with oxidant gas inlet pipe 3. Fuel gas outlet pipe 5 is connected to a lower level portion on the first side of manifold 9 of fuel cell stack 2 such that is does not overlap with oxidant gas inlet pipe 3 and coolant fluid inlet pipe 4. Coolant fluid outlet pipe 6 is connected to an upper level portion on a second side of manifold 9 of fuel cell stack 2. Fuel gas inlet pipe 7 is connected to a middle level portion on the second side of manifold 9 of fuel cell stack 2 such that is does not overlap with coolant fluid outlet pipe 6. Oxidant gas outlet pipe 8 is connected to a lower level portion on the second side of manifold 9 of fuel cell stack 6 such that it does not overlap with fuel gas inlet pipe 7 and coolant fluid outlet pipe 6.

Each of sensors 13-18 comprises a detection device used to detect pressure and temperature of the fluid flowing in one of pipes 3-8. Each of sensors 13-18 include a detection part that may be installed facedown within the respective one of pipes 3-8. The facedown installation prevents accumulation of water within the detection part, which also prevents freezing in the case of low-temperature environments, and allows for control of defects in gas pressure within pipes 3-8.

The fuel cell system may be installed underneath a floor of a vehicle, for example, by positioning connectors for fuel gas outlet pipe 5 and oxidant gas outlet pipe 8 on a lower level portion of manifold 9 of fuel cell stack 2. In this way, fuel gas outlet pipe 5 and oxidant gas outlet pipe 8 drain fluid out of fuel cell stack 2. Therefore, the fluid does not accumulate within fuel gas outlet pipe 5 and oxidant gas outlet pipe 8, which may prevent damage to the outlet pipes due to freezing in a low-temperature environment.

In addition, positioning the connectors on the lower level portion of manifold 9 may reduce the start time of fuel cell stack 2. For example, in this case, fluid accumulated in a gas outlet connector on manifold 9 of fuel cell stack 2 may be drained by installing a means of discharging the fuel gas and the oxidant gas within the gas outlet connector and mixing the fluid with the discharged gas. This prevents adverse effects on power generation of fuel cell stack 2 due to fluid accumulation in a gas outlet connector. In other embodiments, equivalent results may be achieved by installing the fuel cell system near a front of a vehicle.

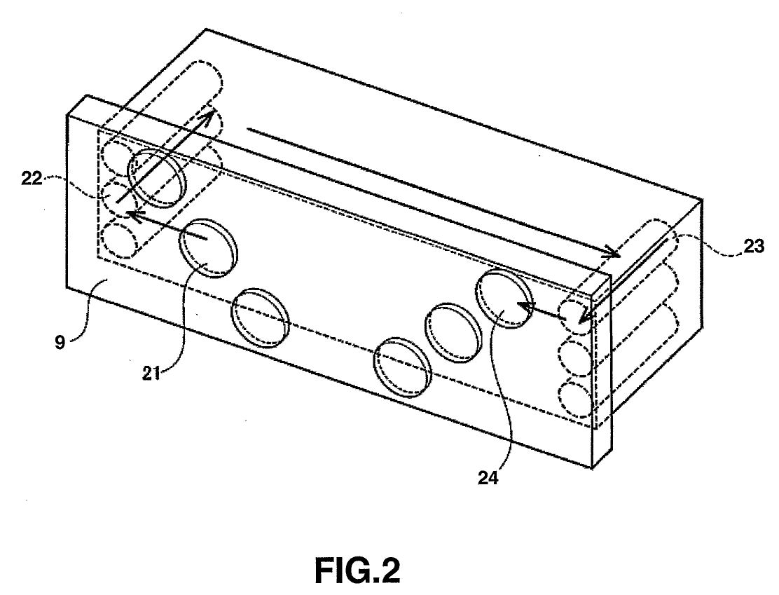

FIG. 2 is a perspective view illustrating a coolant fluid flow through piping structure 1 of fuel cell stack 2 from FIG. 1. In the illustrated embodiment, manifold 9 of fuel cell stack 2 includes a coolant fluid inlet connector 21 positioned on a middle level portion of manifold 9 and a coolant fluid outlet connector 24 positioned on an upper level portion of manifold 9.

For example, coolant fluid inlet pipe 4 (FIG. 1) may connect to coolant fluid inlet connector 21 to supply a coolant fluid to a coolant fluid inlet passage 22 within fuel cell stack 2. Coolant fluid inlet passage 22 then supplies the coolant fluid to each unit fuel cell within fuel cell stack 2. The coolant fluid passes through a coolant fluid passage within each of the unit fuel cells to cool the unit fuel cells. The coolant fluid then enters a coolant fluid outlet passage 23 within fuel cell stack 2. Coolant fluid outlet pipe 6 (FIG. 1) may connect to coolant fluid outlet connector 24 to drain the coolant fluid from coolant fluid outlet passage 23 within fuel cell stack 2. In this case, coolant fluid outlet connector 24 is positioned on the upper level portion of manifold 9, which is above a level of coolant fluid outlet passage 23 within fuel cell stack 2. Therefore, the coolant fluid flows upward from coolant fluid outlet passage 23 into coolant fluid outlet connector 24. In this way, gas, e.g., air, within coolant fluid outlet passage 23 may be discharged into coolant fluid outlet pipe 6 (FIG. 1).

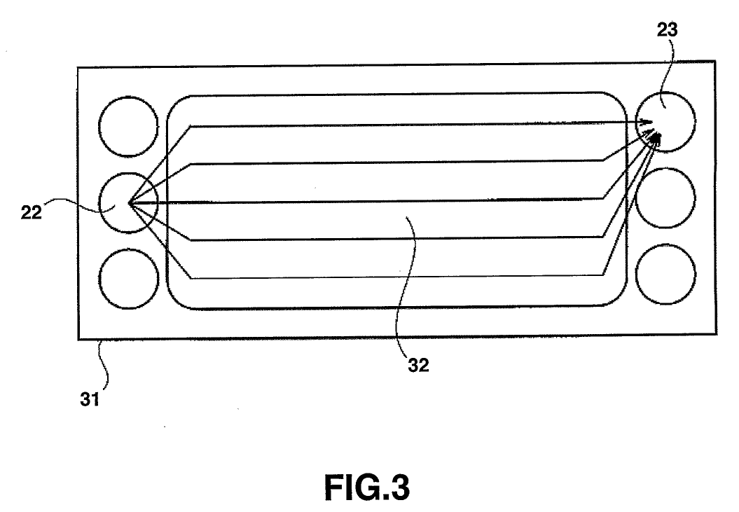

FIG. 3 is a cross-sectional view illustrating a coolant fluid flow through a unit fuel cell 31 within fuel cell stack 2 from FIG. 1. As shown in FIG. 3, the coolant fluid supplied from coolant fluid inlet passage 22 positioned within a middle level portion of fuel cell stack 2 flows through a plurality of coolant fluid passages 32 within fuel cell 31. The plurality of coolant fluid passages 32 are installed one above the other within fuel cell 31 and drain into coolant fluid outlet passage 23 positioned within an upper level portion of fuel cell stack 2.

In the illustrated embodiment, coolant fluid outlet passage 23 is positioned within fuel cell stack 2 above the level of coolant fluid passage 32 within fuel cell 31. Accordingly, the coolant fluid flows upward from coolant fluid passage 32 within fuel cell 31 to coolant fluid outlet passage 23 to enable the gas within coolant fluid passage 32 to be discharged into coolant fluid outlet passage 23.

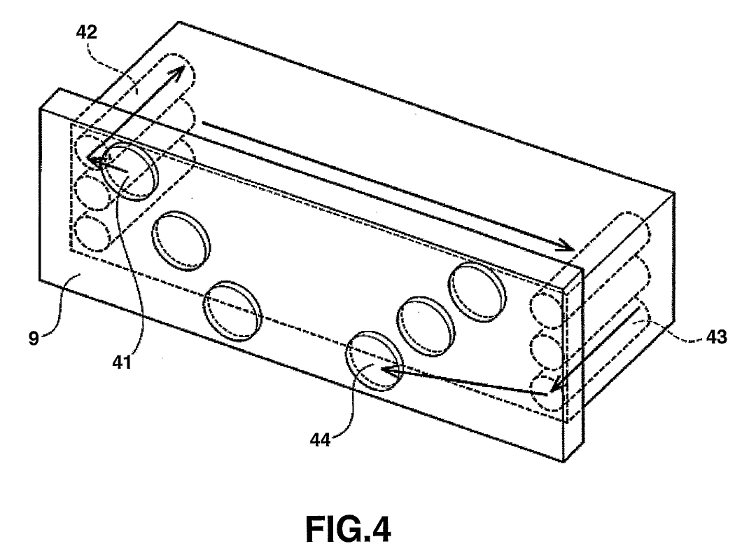

FIG. 4 is a perspective view illustrating an oxidant gas flow through piping structure 1 of fuel cell stack 2 from FIG. 1. In the illustrated embodiment, manifold 9 of fuel cell stack 2 includes an oxidant gas inlet connector 41 positioned on an upper level portion of manifold 9 and an oxidant gas outlet connector 44 positioned on a lower level portion of manifold 9.

For example, oxidant gas inlet pipe 3 (FIG. 1) may connect to oxidant gas inlet connector 41 to supply an oxidant gas to an oxidant gas inlet passage 42 within fuel cell stack 2. Oxidant gas inlet passage 42 then supplies the oxidant gas to each unit fuel cell within fuel cell stack 2. The oxidant gas passes through an oxidant gas passage within each of the unit fuel cells in order to be supplied to cathodes of the unit fuel cells. In the cathode, a reaction occurs in which water is generated by supplying oxygen to hydrogen ions permeating an electrolyte membrane and electrons circulating the external circuit (2H⁺+2e⁻+(½)O₂→H₂O).

Unconsumed oxidant gas and steam generated during the reaction enter an oxidant gas outlet passage 43 within fuel cell stack 2. Oxidant gas outlet pipe 8 (FIG. 1) may connect to oxidant gas outlet connector 44 to discharge the oxidant gas from oxidant gas outlet passage 43 within fuel cell stack 2. In this case, oxidant gas outlet connector 44 is positioned on the lower level portion of manifold 9, which is below a level of oxidant gas outlet passage 43 within fuel cell stack 2. Therefore, the oxidant gas flows downward from oxidant gas outlet passage 43 into oxidant gas outlet connector 44. In this way, fluid, e.g., water, within oxidant gas outlet passage 43 may be discharged into oxidant gas outlet pipe 8 (FIG. 1). In this way, defects in the power generation of fuel cell stack 2 due to flooding (e.g., fluid accumulation within fuel cell stack 2) may be prevented.

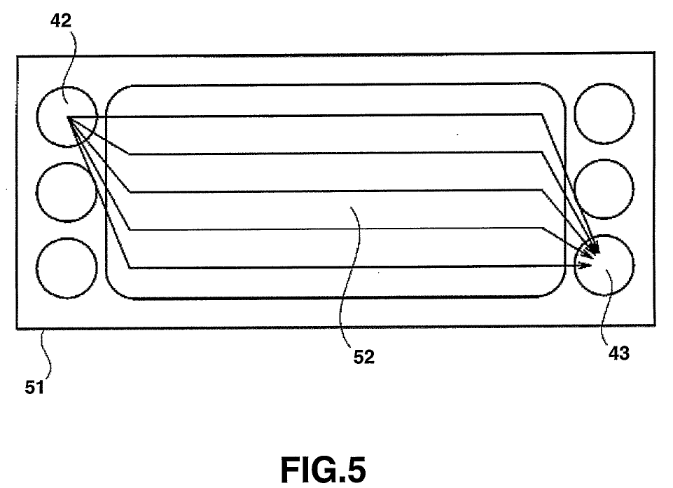

FIG. 5 is a cross-sectional view illustrating an oxidant gas flow through a unit fuel cell 51 within fuel cell stack 2 from FIG. 1. As shown in FIG. 5, the oxidant gas supplied from oxidant gas inlet passage 42 positioned within an upper level portion of fuel cell stack 2 flows through a plurality of oxidant gas passages 52 within fuel cell 51. The plurality of oxidant gas passages 52 are installed one above the other within fuel cell 51 and discharge into oxidant gas outlet passage 43 positioned within a lower level portion of fuel cell stack 2.

In the illustrated embodiment, oxidant gas outlet passage 43 is positioned within fuel cell stack 2 above the level of oxidant gas passage 52 within fuel cell 51. Accordingly, the oxidant gas flows downward from oxidant gas passage 52 within fuel cell 51 to oxidant gas outlet passage 43 to enable the fluid within oxidant gas passage 52 to be drained into oxidant gas outlet passage 43.

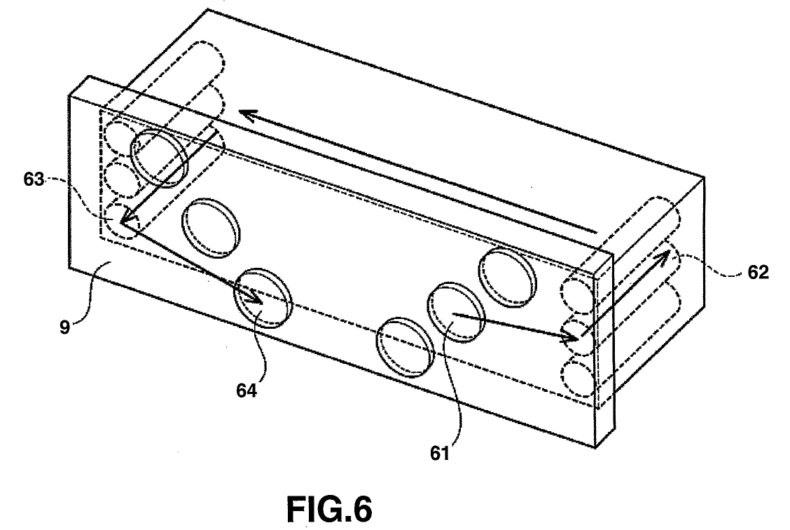

FIG. 6 is a perspective view illustrating a fuel gas flow through piping structure 1 of fuel cell stack 2 from FIG. 1. In the illustrated embodiment, manifold 9 of fuel cell stack 2 includes a fuel gas inlet connector 61 positioned on a middle level portion of manifold 9 and a fuel gas outlet connector 64 positioned on a lower level portion of manifold 9.

For example, fuel gas inlet pipe 7 (FIG. 1) may connect to fuel gas inlet connector 61 to supply a fuel gas to a fuel gas inlet passage 62 within fuel cell stack 2. Fuel gas inlet passage 62 then supplies the fuel gas to each unit fuel cell within fuel cell stack 2. The fuel gas passes through a fuel gas passage within each of the unit fuel cells in order to be supplied to anodes of the unit fuel cells. In the anode, a reaction occurs in which hydrogen gas converts into hydrogen ions and electrons (H₂→2H⁺+2e⁻).

Unconsumed fuel gas enters a fuel gas outlet passage 63 within fuel cell stack 2. Fuel gas outlet pipe 5 (FIG. 1) may connect to fuel gas outlet connector 64 to discharge the fuel gas from fuel gas outlet passage 63 within fuel cell stack 2. In this case, fuel gas outlet connector 64 is positioned on the lower level portion of manifold 9, which is below a level of fuel gas outlet passage 63 within fuel cell stack 2. Therefore, the fuel gas flows downward from fuel gas outlet passage 63 into fuel gas outlet connector 64. In this way, fluid, e.g., water, within fuel gas outlet passage 63 may be discharged into fuel gas outlet pipe 5 (FIG. 1). In this way, defects in the power generation of fuel cell stack 2 due to flooding (e.g., fluid accumulation within fuel cell stack 2) may be prevented.

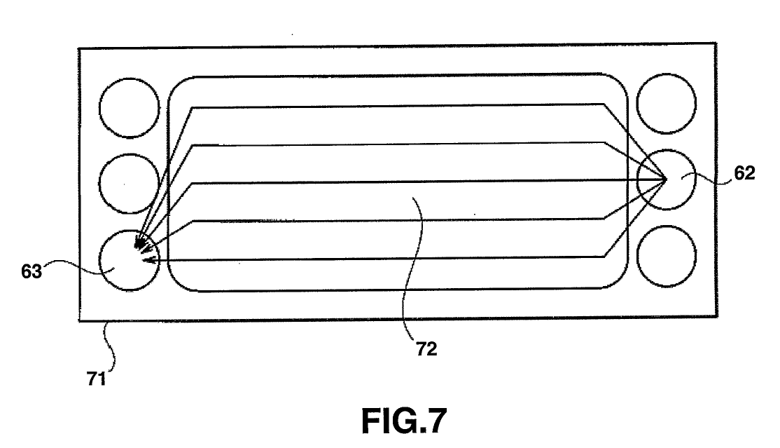

FIG. 7 is a cross-sectional view illustrating a fuel gas flow through a unit fuel cell 71 within fuel cell stack 2 from FIG. 1. As shown in FIG. 7, the fuel gas supplied from fuel gas inlet passage 62 positioned within a middle level portion of fuel cell stack 2 flows through a plurality of fuel gas passages 72 within fuel cell 71. The plurality of fuel gas passages 72 are installed one above the other within fuel cell 71 and discharge into fuel gas outlet passage 63 positioned within a lower level portion of fuel cell stack 2.

In the illustrated embodiment, fuel gas outlet passage 63 is positioned within fuel cell stack 2 above the level of fuel gas passage 72 within fuel cell 71. Accordingly, the fuel gas flows downward from fuel gas passage 72 within fuel cell 71 to fuel gas outlet passage 63 to enable the fluid within fuel gas passage 72 to be drained into fuel gas outlet passage 63.

As described above, piping structure 1 of fuel cell stack 2 includes coolant fluid outlet connector 24 that connects coolant fluid outlet pipe 6, used for draining the coolant fluid from fuel cell stack 2, to fuel cell stack 2. Coolant fluid outlet connector 24 is positioned on manifold 9 of fuel cell stack 2 above a level of coolant fluid passage 32 within fuel cell stack 2. Therefore, the coolant fluid within fuel cell stack 2 may flow upward from coolant fluid passage 32 to coolant fluid outlet connector 24. In this way, piping structure 1 enables gas within coolant fluid passage 32 to be discharged from fuel cell stack 2 without accumulating within coolant fluid passage 32. Discharging the gas from coolant fluid passage 32 within fuel cell stack 2 improves the cooling performance of the coolant fluid and the power generation performance and life of fuel cell stack 2.

In addition, piping structure 1 of fuel cell stack 2 includes fuel gas outlet connector 64 that connects fuel gas outlet pipe 5, used for discharging the fuel gas from fuel cell stack 2, to fuel cell stack 2. Fuel gas outlet connector 64 is positioned on manifold 9 of fuel cell stack 2 below a level of fuel gas passage 72.within fuel cell stack 2. Therefore, the fuel gas within fuel cell stack 2 may flow downward from fuel gas passage 72 to fuel gas outlet connector 64. In this way, piping structure 1 enables fluid within fuel gas passage 62 to be drained from fuel cell stack 2 without accumulating within fuel gas passage 72. Draining the fluid from fuel gas passage 72 within fuel cell stack 2 prevents defects in the power generation of fuel cell stack 2 due to flooding.

Furthermore, piping structure 1 of fuel cell stack 2 includes oxidant gas outlet connector 44 that connects oxidant gas outlet pipe 8, used for discharging the oxidant gas from fuel cell stack 2, to fuel cell stack 2. Oxidant gas outlet connector 44 is positioned on manifold 9 of fuel cell stack 2 below a level of oxidant gas passage 52 within fuel cell stack 2. Therefore, the oxidant gas within fuel cell stack 2 may flow downward from oxidant gas passage 52 to oxidant gas outlet connector 54. In this way, piping structure 1 enables fluid within oxidant gas passage 52 to be drained from fuel cell stack 2 without accumulating within oxidant gas passage 52. Draining the fluid from oxidant gas passage 52 within fuel cell stack 2 prevents defects in the power generation of fuel cell stack 2 due to flooding.

In the illustrated embodiment, coolant fluid outlet pipe 6 and oxidant gas outlet pipe 8 are positioned on the same side of manifold 9 of fuel cell stack 2, and fuel gas outlet pipe 5 is positioned on a different side of manifold 9 of fuel cell stack 2. This arrangement enables a rise in temperature of the coolant fluid passing by an outlet of the cathode in which flooding may occur, and prevents concentration of the fluid that causes flooding. In addition, when each fluid flows horizontally within fuel cell stack 2, a distance between a stack gateway manifold and manifold 9 of fuel cell stack 2 can be reduced, which enables a reduction in weight and cost of piping structure 1 of fuel cell stack 2.

As shown in FIG. 1, pipes 3-8 connected to fuel cell stack 2 are positioned one above the other such that each of pipes 3-8 are not positioned directly above or below another one of pipes 3-8. In this way, space may be secured above or below pipes 3-8 for installation of sensors 13-18 within pipes 3-8. In addition, positioning adjacent pipes 3-8 on manifold 9 so as not to overlap ensures tool space and hand space when connecting pipes 3-8 to fuel cell stack 2 and reduces the assembly time.

Furthermore, one of sensors 13-18 may be installed within the respective one of pipes 3-8 substantially adjacent to the connector for the pipe positioned on manifold 9 of fuel cell stack 2. Properly installing sensors 13-18 within pipes 3-8 may reduce effects of pressure damages due to changes in layout of pipes 3-8, and may also reduce the possibility of errors between sensor readout numbers and actual values. Therefore, gas conditions within fuel cell stack 2 may be accurately controlled based on sensor readout values, which can improve the life and power generating performance of fuel cell stack 2. Furthermore, a detection part of each of sensors 13-18 faces downward when installed within pipes 3-8 to prevent fluid from pooling in the detection part and possibly freezing in a low-temperature environment. In addition, installing sensors 13-18 within pipes 3-8 with detection parts facing downward allows further control over gas pressure during power generation in fuel cell stack 2.

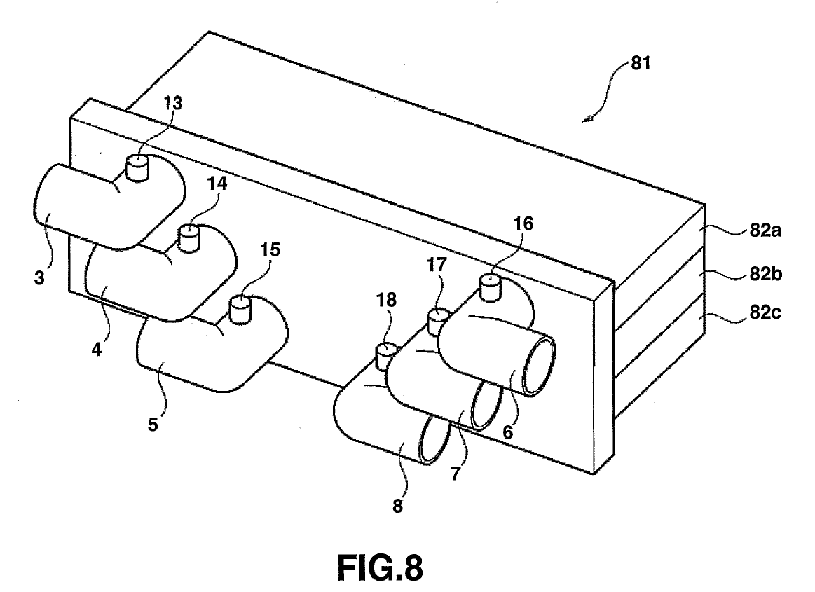

FIG. 8 is a perspective view illustrating a piping structure 81 of a set of fuel cell stacks 82a-82c in accordance with another embodiment of the invention. As shown in FIG. 8, piping structure 81 includes a set of fuel cell stacks 82a-82c layered in a direction of the gravitational force. Piping structure 81 of the set of fuel cell stacks 82a-82c includes inlet and outlet pipes 3-8 and sensors 13-18 installed within pipes 3-8 substantially similar to FIG. 1.

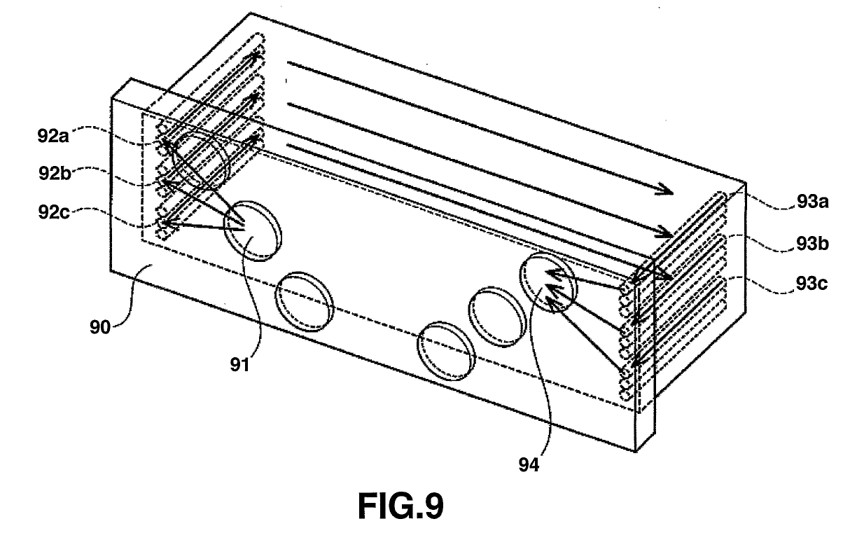

FIG. 9 is a perspective view illustrating a coolant fluid flow through piping structure 81 of the set of fuel cell stacks 82a-82c from FIG. 8. In the illustrated embodiment, a manifold 90 of the set of fuel cell stacks 82a-82c includes a coolant fluid inlet connector 91 positioned on a middle level portion of manifold 90 and a coolant fluid outlet connector 94 positioned on an upper level portion of manifold 90.

For example, coolant fluid inlet pipe 4 (FIG. 8) may connect to coolant fluid inlet connector 91 to supply a coolant fluid to each of coolant fluid inlet passages 92a-92c within the set of fuel cell stacks 82a-82c. Coolant fluid inlet passages 92a-92c then supply the coolant fluid to each unit fuel cell within the set of fuel cell stacks 82a-82c. The coolant fluid passes through a coolant fluid passage within each unit fuel cell of the set of fuel cell stacks 82a-82c to cool the unit fuel cells. The coolant fluid then enters each of coolant fluid outlet passages 93a-93c within the set of fuel cell stacks 82a-82c. Coolant fluid outlet pipe 6 (FIG. 8) may connect to coolant fluid outlet connector 94 to drain the coolant fluid from coolant fluid outlet passages 93a-93c within the set of fuel cell stacks 82a-82c.

In this case, coolant fluid outlet connector 94 is positioned on the upper level portion of manifold 90, which is above a level of each of coolant fluid outlet passages 93a-93c within the set of fuel cell stacks 82a-82c. Therefore, the coolant fluid flows upward from coolant fluid outlet passages 93a-93c into coolant fluid outlet connector 94. In this way, gas, e.g., air, within coolant fluid outlet passages 93a-93c may be discharged into coolant fluid outlet pipe 6 (FIG. 8).

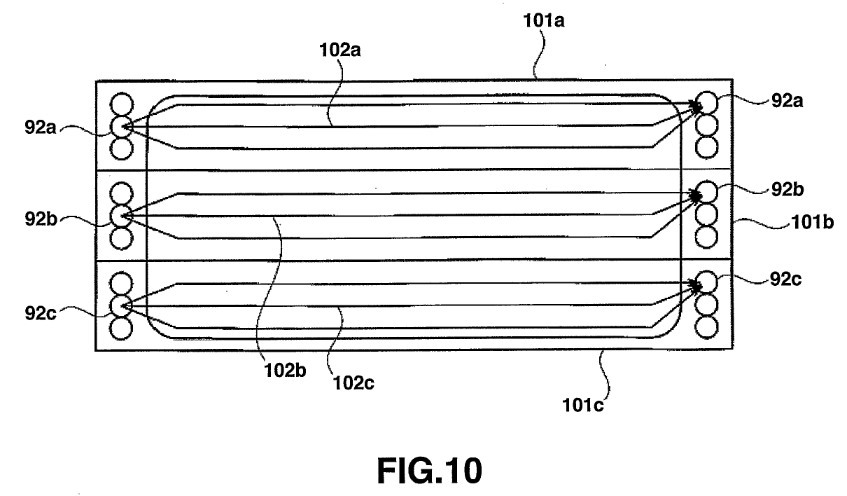

FIG. 10 is a cross-sectional view illustrating a coolant fluid flow through each of unit fuel cells 101a-101c within the set of fuel cell stacks 82 from FIG. 8. As shown in FIG. 10, the coolant fluid supplied from coolant fluid inlet passages 92a-92c positioned within a middle level portion of each of the set of fuel cell stacks 82a-82c flows through a plurality of coolant fluid passages 102a-102c within each of fuel cells 101a-101c. Each of the plurality of coolant fluid passages 102a-102c are installed one above the other within fuel cells 101a-101c and drain into coolant fluid outlet passages 93a-93c positioned within an upper level portion of each of the set of fuel cell stacks 82a-82c.

In the illustrated embodiment, each of coolant fluid outlet passages 93a-93c are positioned within the set of fuel cell stacks 82a-82c above the level of the respective one of coolant fluid passages 102a-102c within fuel cells 101a-101c. Accordingly, the coolant fluid flows upward from coolant fluid passages 102a-102c within fuel cells 101a-101c to coolant fluid outlet passages 93a-93c to enable the gas within coolant fluid passages 102a-102c to be discharged into coolant fluid outlet passages 93a-93c.

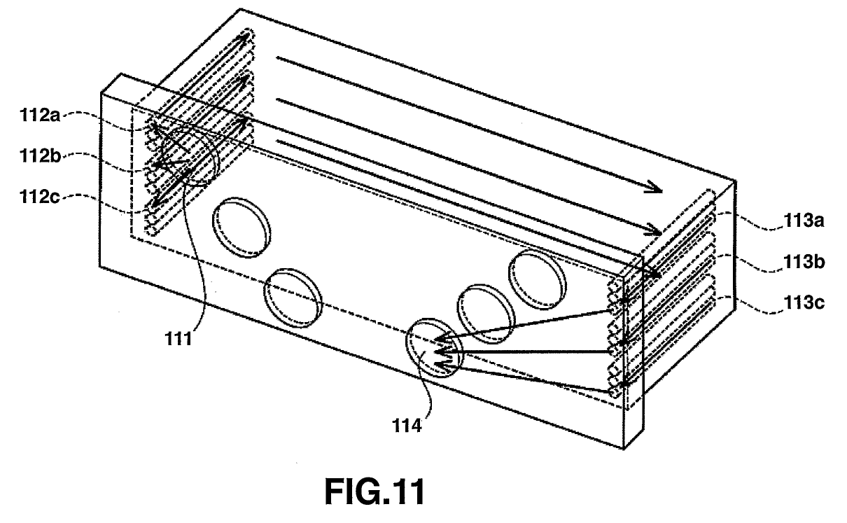

FIG. 11 is a perspective view illustrating an oxidant gas flow through piping structure 81 of the set of fuel cell stacks 82a-82c from FIG. 8. In the illustrated embodiment, a manifold 90 of the set of fuel cell stacks 82a-82c includes an oxidant gas inlet connector 111 positioned on an upper level portion of manifold 90 and an oxidant gas outlet connector 114 positioned on a lower level portion of manifold 90.

For example, oxidant gas inlet pipe 3 (FIG. 8) may connect to oxidant gas inlet connector 111 to supply an oxidant gas to each of oxidant gas inlet passages 112a-112c within the set of fuel cell stacks 82a-82c. Oxidant gas inlet passages 112a-112c then supply the oxidant gas to each unit fuel cell within the set of fuel cell stacks 82a-82c. The oxidant gas passes through an oxidant gas passage within each unit fuel cell of the set of fuel cell stacks 82a-82c in order to be supplied to cathodes of the unit fuel cells. In the cathode, a reaction occurs in which water is generated by supplying oxygen to hydrogen ions permeating an electrolyte membrane and electrons circulating the external circuit (2H⁺+2e⁻+(½)O₂→H₂O).

Unconsumed oxidant gas and steam generated during the reaction enter each of oxidant gas outlet passages 113a-113c within the set of fuel cell stacks 82a-82c. Oxidant gas outlet pipe 8 (FIG. 8) may connect to oxidant gas outlet connector 114 to drain the oxidant gas from oxidant gas outlet passages 113a-113c within the set of fuel cell stacks 82a-82c. In this case, oxidant gas outlet connector 114 is positioned on the lower level portion of manifold 90, which is below a level of each of oxidant gas outlet passages 113a-113c within the set of fuel cell stacks 82a-82c. Therefore, the oxidant gas flows downward from oxidant gas outlet passages 113a-113c into oxidant gas outlet connector 114. In this way, fluid, e.g., water, within oxidant gas outlet passages 113a-113c may be discharged into oxidant gas outlet pipe 8 (FIG. 8). In this way, defects in the power generation of the set of fuel cell stacks 82 due to flooding (e.g., fluid accumulation within the set of fuel cell stacks 82) may be prevented.

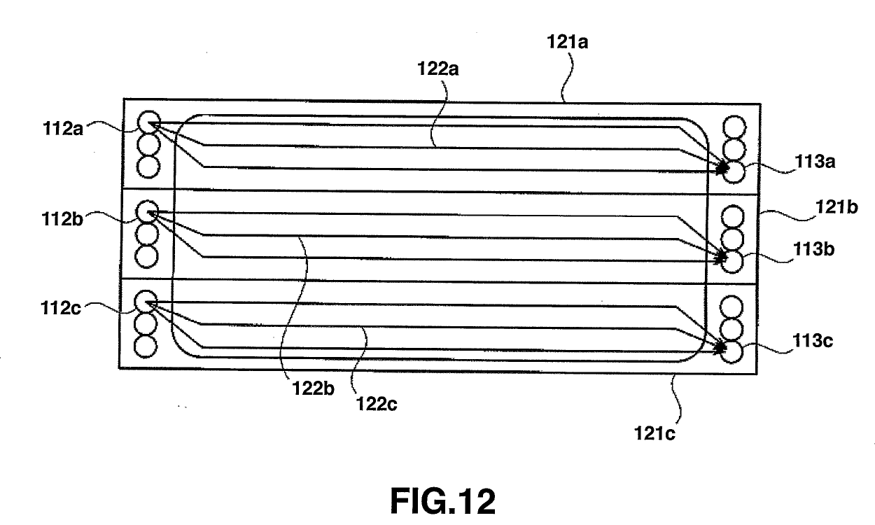

FIG. 12 is a cross-sectional view illustrating an oxidant gas flow through each of unit fuel cells 121a-121c within the set of fuel cell stacks 82 from FIG. 8. As shown in FIG. 12, the oxidant gas supplied from oxidant gas inlet passages 112a-112c positioned within an upper level portion of each of the set of fuel cell stacks 82a-82c flows through a plurality of oxidant gas passages 122a-122c within each of fuel cells 121a-121c. Each of the plurality of oxidant gas passages 122a-122c are installed one above the other within fuel cells 121a-121c and discharge into oxidant gas outlet passages 113a-113c positioned within a lower level portion of each of the set of fuel cell stacks 82a-82c.

In the illustrated embodiment, each of oxidant gas outlet passages 113a-113c are positioned within the set of fuel cell stacks 82a-82c below the level of the respective one of oxidant gas passages 122a-122c within fuel cells 121a-121c. Accordingly, the oxidant gas flows downward from oxidant gas passages 122a-122c within fuel cells 121a-121c to oxidant gas outlet passages 113a-113c to enable the fluid within oxidant gas passages 122a-122c to be drained into oxidant gas outlet passages 113a-113c.

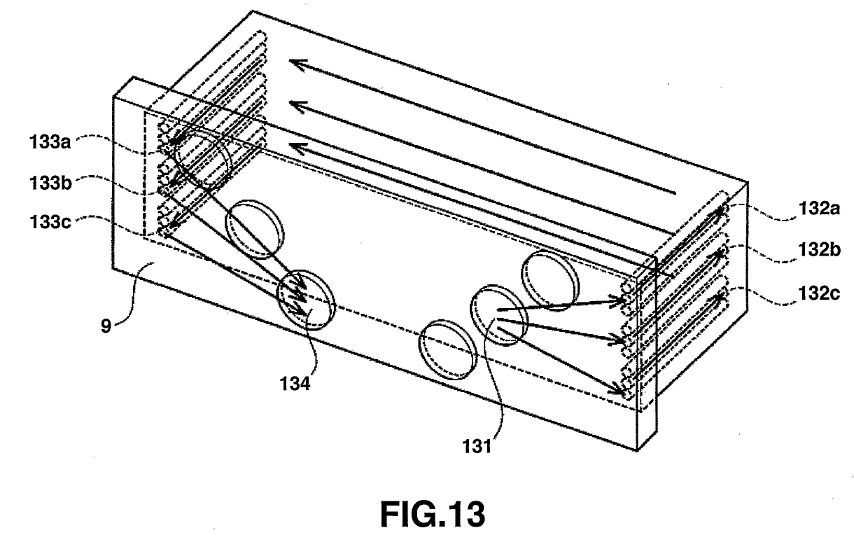

FIG. 13 is a perspective view illustrating a fuel gas flow through piping structure 81 of the set of fuel cell stacks 82a-82c from FIG. 8. In the illustrated embodiment, a manifold 90 of the set of fuel cell stacks 82a-82c includes a fuel gas inlet connector 131 positioned on a middle level portion of manifold 90 and a fuel gas outlet connector 134 positioned on a lower level portion of manifold 90.

For example, fuel gas inlet pipe 7 (FIG. 8) may connect to fuel gas inlet connector 131 to supply a fuel gas to each of fuel gas inlet passages 132a-132c within the set of fuel cell stacks 82a-82c. Fuel gas inlet passages 132a-132c then supply the fuel gas to each unit fuel cell within the set of fuel cell stacks 82a-82c. The fuel gas passes through a fuel gas passage within each unit fuel cell of the set of fuel cell stacks 82a-82c in order to be supplied to anodes of the unit fuel cells. In the anode, a reaction occurs in which hydrogen gas converts into hydrogen ions and electrons (H₂→2H⁺+2e⁻).

Unconsumed fuel gas enters each of fuel gas outlet passages 133a-133c within the set of fuel cell stacks 82a-82c. Fuel gas outlet pipe 5 (FIG. 8) may connect to fuel gas outlet connector 134 to drain the fuel gas from oxidant gas outlet passages 133a-133c within the set of fuel cell stacks 82a-82c. In this case, fuel gas outlet connector 134 is positioned on the lower level portion of manifold 90, which is below a level of each of fuel gas outlet passages 133a-133c within the set of fuel cell stacks 82a-82c. Therefore, the fuel gas flows downward from fuel gas outlet passages 133a-133c into fuel gas outlet connector 134. In this way, fluid, e.g., water, within fuel gas outlet passages 133a-133c may be discharged into fuel gas outlet pipe 5 (FIG. 8). In this way, defects in the power generation of the set of fuel cell stacks 82 due to flooding (e.g., fluid accumulation within the set of fuel cell stacks 82) may be prevented.

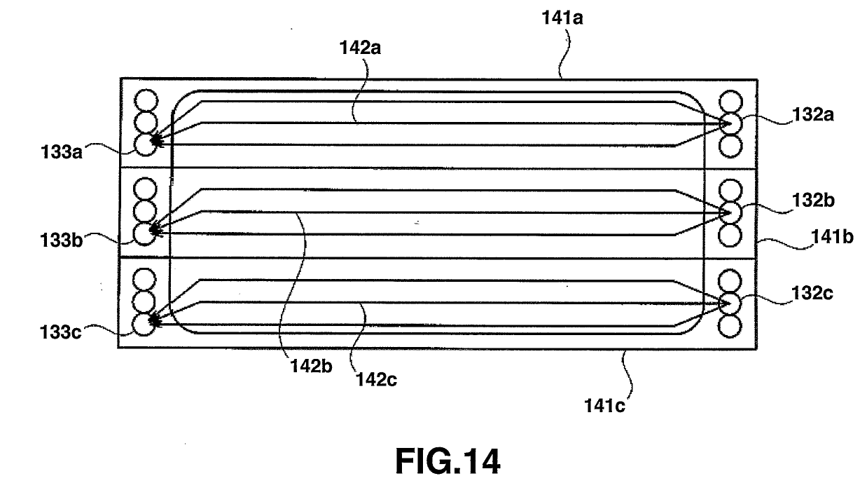

FIG. 14 is a cross-sectional view illustrating a fuel gas flow through each of unit fuel cells 141a-141c within the set of fuel cell stacks 82 from FIG. 8. As shown in FIG. 14, the fuel gas supplied from fuel gas inlet passages 132a-132c positioned within a middle level portion of each of the set of fuel cell stacks 82a-82c flows through a plurality of fuel gas passages 142a-142c within each of fuel cells 141a-141c. Each of the plurality of fuel gas passages 142a-142c are installed one above the other within fuel cells 141a-141c and discharge into fuel gas outlet passages 133a-133c positioned within a lower level portion of each of the set of fuel cell stacks 82a-82c.

In the illustrated embodiment, each of fuel gas outlet passages 133a-133c are positioned within the set of fuel cell stacks 82a-82c below the level of the respective one of fuel gas passages 132a-132c within fuel cells 131a-131c. Accordingly, the fuel gas flows downward from fuel gas passages 132a-132c within fuel cells 131a-131c to fuel gas outlet passages 133a-133c to enable the fluid within fuel gas passages 142a-142c to be drained into fuel gas outlet passages 133a-133c.

As described above, piping structure 81 of the set of fuel cell stacks 82a-82c includes coolant fluid outlet connector 94 positioned on manifold 90 of the set of fuel cell stacks 82a-82c above a level of coolant fluid passages 102a-102c within the set of fuel cell stacks 82a-82c. Therefore, the coolant fluid within the set of fuel cell stacks 82a-82c may flow upward from coolant fluid passages 102a-102c to coolant fluid outlet connector 94. In this way, piping structure 81 enables gas within coolant fluid passages 102a-102c to be discharged from the set of fuel cell stacks 82a-82c without accumulating within coolant fluid passages 102a-102c. Discharging the gas from coolant fluid passages 102a-102c within the set of fuel cell stacks 82a-82c improves the cooling performance of the coolant fluid and the power generation performance and life of the set of fuel cell stacks 82a-82c.

In addition, piping structure 81 of the set of fuel cell stacks 82a-82c includes fuel gas outlet connector 134 positioned on manifold 90 of the set of fuel cell stacks 82a-82c below a level of fuel gas passages 142a-142c within the set of fuel cell stacks 82a-82c. Therefore, the fuel gas within the set of fuel cell stacks 82a-82c may flow downward from fuel gas passages 142a-142c to fuel gas outlet connector 134. Furthermore, piping structure 81 of the set of fuel cell stacks 82a-82c includes oxidant gas outlet connector 114 positioned on manifold 90 of the set of fuel cell stacks 82a-82c below a level of oxidant gas passages 122a-122c within the set of fuel cell stacks 82a-82c. Therefore, the oxidant gas within the set of fuel cell stacks 82a-82c may flow downward from oxidant gas passages 122a-122c to oxidant gas outlet connector 114. In this way, piping structure 81 enables fluid within fuel gas passages 142a-142c and oxidant gas passages 122a-122c to be discharged from the set of fuel cell stacks 82a-82c without accumulating within fuel gas passages 142a-142c and oxidant gas passages 122a-122c. Draining the fluid from fuel gas passages 142a-142c and oxidant gas passages 122a-122c within the set of fuel cell stacks 82a-82c prevents defects in the power generation of the set of fuel cell stacks 82a-82c due to flooding.

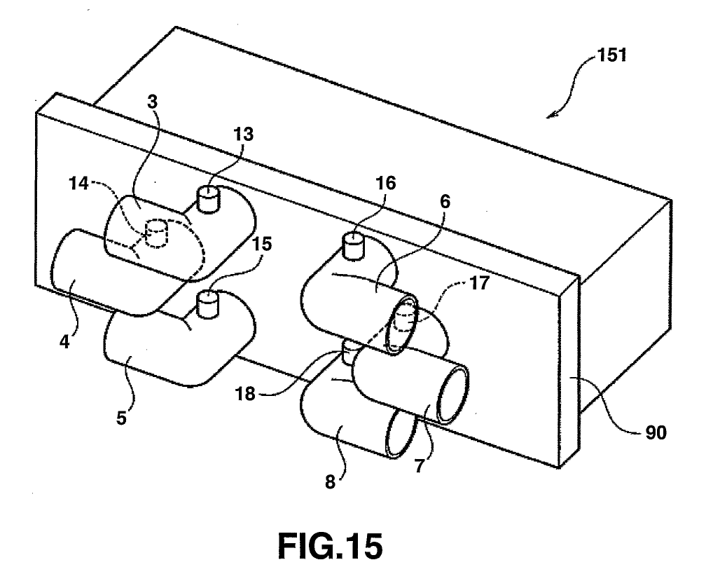

FIG. 1 and FIG. 8 illustrate exemplary piping structures of fuel cells stacks in which the pipes connected to the manifold of the fuel cell stacks are positioned diagonally such that each of the pipes are not positioned directly above or below another one of the pipes. FIG. 15 is a perspective view illustrating a piping structure 151 of a fuel cell stack in accordance with a further embodiment of the invention. As shown in FIG. 15, the pipes may be positioned on a manifold 90 of the fuel cell stack so as to overlap alternately. In other words, each of the pipes may be positioned directly above or below a non-adjacent one of the pipes. Piping structure 151 may operate substantially similar to piping structure 1 (FIG. 1) and piping structure 81 (FIG. 8) described herein.

Various embodiments of the invention have been described. These and other embodiments are within the scope of the following claims.

1. A piping structure of a fuel cell stack comprising:
a coolant fluid inlet connector and a coolant fluid outlet connector positioned on a manifold of the fuel cell stack;
a coolant fluid passage within the fuel cell stack that connects to the coolant fluid inlet connector and the coolant fluid outlet connector;
a coolant fluid inlet pipe that connects to the coolant fluid inlet connector to supply a coolant fluid to the coolant fluid passage; and
a coolant fluid outlet pipe that connects to the coolant fluid outlet connector to drain the coolant fluid from the coolant fluid passage,
wherein the coolant fluid outlet connector is positioned on the manifold of the fuel cell stack above a level of the coolant fluid passage within the fuel cell stack to enable gas to be discharged from the coolant fluid outlet pipe.

2. The piping structure of claim 1, wherein the coolant fluid passage comprises a plurality of coolant fluid passages within the fuel cell stack, wherein each of the coolant fluid passages connects to the coolant fluid inlet connector and the coolant fluid outlet connector.

3. The piping structure of claim 1, wherein the coolant fluid comprises cold water that passes through the coolant fluid passage to cool the fuel cell stack.

4. The piping structure of claim 1, wherein the gas comprises at least one of an oxidant gas or a fuel gas.

5. The piping structure of claim 1, further comprising:
a sensor installed within the coolant fluid inlet pipe substantially adjacent to the coolant fluid inlet connector positioned on the manifold of the fuel cell stack; and
another sensor installed within the coolant fluid outlet pipe substantially adjacent to the coolant fluid outlet connector positioned on the manifold of the fuel cell stack.

6. The piping structure of claim 1 wherein the fuel cell stack comprises a set of fuel cell stacks layered in a direction of the gravitational force, wherein each of the set of fuel cell stacks comprises a coolant fluid passage that connects to the coolant fluid inlet connector and the coolant fluid outlet connector positioned on the manifold of the set of fuel cell stacks.

7. The piping structure of claim 1, further comprising:
a fuel gas inlet connector and a fuel gas outlet connector positioned on the manifold of the fuel cell stack;
a fuel gas passage within the fuel cell stack that connects to the fuel gas inlet connector and the fuel gas outlet connector;
a fuel gas inlet pipe that connects to the fuel gas inlet connector to supply a fuel gas to the fuel gas passage; and
a fuel gas outlet pipe that connects to the fuel gas outlet connector to discharge the fuel gas from the fuel gas passage,
wherein the fuel gas outlet connector is positioned on the manifold of the fuel cell stack below a level of the fuel gas passage within the fuel cell stack to enable fluid to be drained from the fuel gas outlet pipe.

8. The piping structure of claim 7, wherein the fuel gas passage comprises a plurality of fuel gas passages within the fuel cell stack, wherein each of the fuel gas passages connects to the fuel gas inlet connector and the fuel gas outlet connector.

9. The piping structure of claim 7, further comprising:
a sensor installed within the fuel gas inlet pipe substantially adjacent to the fuel gas inlet connector positioned on the manifold of the fuel cell stack; and
another sensor installed within the fuel gas outlet pipe substantially adjacent to the fuel gas outlet connector positioned on the manifold of the fuel cell stack.

10. The piping structure of claim 7, wherein the fuel cell stack comprises a set of fuel cell stacks layered in a direction of the gravitational force, wherein each of the set of fuel cell stacks comprises a fuel gas passage that connects to the fuel gas inlet connector and the fuel gas outlet connector positioned on the manifold of the set of fuel cell stacks.

11. The piping structure of claim 1, further comprising:
an oxidant gas inlet connector and an oxidant gas outlet connector positioned on the manifold of the fuel cell stack; an oxidant gas passage within the fuel cell stack that connects to the oxidant gas inlet connector and the oxidant gas outlet connector;
an oxidant gas inlet pipe that connects to the oxidant gas inlet connector to supply an oxidant gas to the oxidant gas passage; and
an oxidant gas outlet pipe that connects to the oxidant gas outlet connector to discharge the oxidant gas from the fuel gas passage,
wherein the oxidant gas outlet connector is positioned on the manifold of the fuel cell stack below a level of the oxidant gas passage within the fuel cell stack to enable fluid to be discharged from the oxidant gas outlet pipe.

12. The piping structure of claim 11, wherein the oxidant gas passage comprises a plurality of oxidant gas passages within the fuel cell stack, wherein each of the oxidant gas passages connects to the oxidant gas inlet connector and the oxidant gas outlet connector.

13. The piping structure of claim 1, further comprising:
a sensor installed within the oxidant gas inlet pipe substantially adjacent to the oxidant gas inlet connector positioned on the manifold of the fuel cell stack; and
another sensor installed within the oxidant gas outlet pipe substantially adjacent to the oxidant gas outlet connector positioned on the manifold of the fuel cell stack.

14. The piping structure of claim 11, wherein the fuel cell stack comprises a set of fuel cell stacks layered in a direction of the gravitational force, wherein each of the set of fuel cell stacks comprises an oxidant gas passage that connects to the oxidant gas inlet connector and the oxidant gas outlet connector positioned on the manifold of the set of fuel cell stacks.

15. The piping structure of claim 1, further comprising a fuel gas inlet connector and a fuel gas outlet connector positioned on the manifold of the fuel cell stack, and an oxidant gas inlet connector and an oxidant gas outlet connector positioned on the manifold of the fuel cell stack.

16. The piping structure of claim 15, wherein the connectors are positioned on the manifold of the fuel cell stack such that each of the connectors are not positioned directly above or below another one of the connectors.

17. The piping structure of claim 15, wherein the coolant fluid outlet connector and the oxidant gas outlet connector are positioned on one side of the manifold of the fuel cell stack and the fuel gas outlet connector is positioned on another side of the manifold of the fuel cell stack.

18. A method of manufacturing a piping structure of a fuel cell stack comprising:
positioning a coolant fluid inlet connector and a coolant fluid outlet connector on a manifold of the fuel cell stack;
connecting a coolant fluid passage within the fuel cell stack to the coolant fluid inlet connector and the coolant fluid outlet connector;
connecting a coolant fluid inlet pipe to the coolant fluid inlet connector to supply a coolant fluid to the coolant fluid passage; and
connecting a coolant fluid outlet pipe to the coolant fluid outlet connector to drain the coolant fluid from the coolant fluid passage,
wherein positioning the coolant fluid outlet connector comprises positioning the coolant fluid outlet connector on the manifold of the fuel cell stack above a level of the coolant fluid passage within the fuel cell stack to enable gas to be discharged from the coolant fluid outlet pipe.

19. The method of claim 18, wherein the coolant fluid passage comprises a plurality of coolant fluid passages within the fuel cell stack, the method further comprising connecting each of the coolant fluid passages to the coolant fluid inlet connector and the coolant fluid outlet connector.

20. The method of claim 18, further comprising:
installing a sensor within the coolant fluid inlet pipe substantially adjacent to the coolant fluid inlet connector positioned on the manifold of the fuel cell stack; and
installing another sensor within the coolant fluid outlet pipe substantially adjacent to the coolant fluid outlet connector positioned on the manifold of the fuel cell stack.

21. The method of claim 18, wherein the fuel cell stack comprises a set of fuel cell stacks layered in a direction of the gravitational force, the method further comprising connecting a coolant fluid passage within each of the set of fuel cell stacks to the coolant fluid inlet connector and the coolant fluid outlet connector positioned on the manifold of the set of fuel cell stacks.

22. The method of claim 19, further comprising:
positioning a fuel gas inlet connector and a fuel gas outlet connector on the manifold of the fuel cell stack;
connecting a fuel gas passage within the fuel cell stack to the fuel gas inlet connector and the fuel gas outlet connector;
connecting a fuel gas inlet pipe to the fuel gas inlet connector to supply a fuel gas to the fuel gas passage; and
connecting a fuel gas outlet pipe to the fuel gas outlet connector to discharge the fuel gas from the fuel gas passage,
wherein positioning the fuel gas outlet connector comprises positioning the fuel gas outlet connector on the manifold of the fuel cell stack below a level of the fuel gas passage within the fuel cell stack to enable fluid to be drained from the fuel gas outlet pipe.

23. The method of claim 22, wherein the fuel gas passage comprises a plurality of fuel gas passages within the fuel cell stack, the method further comprising connecting each of the fuel gas passages to the fuel gas inlet connector and the fuel gas outlet connector.

24. The method of claim 22, further comprising:
installing a sensor within the fuel gas inlet pipe substantially adjacent to the fuel gas inlet connector positioned on the manifold of the fuel cell stack; and
installing another sensor within the fuel gas outlet pipe substantially adjacent to the fuel gas outlet connector positioned on the manifold of the fuel cell stack.

25. The method of claim 22, wherein the fuel cell stack comprises a set of fuel cell stacks layered in a direction of the gravitational force, the method further comprising connecting a fuel gas passage within each of the set of fuel cell stacks to the fuel gas inlet connector and the fuel gas outlet connector positioned on the manifold of the set of fuel cell stacks.

26. The method of claim 18, further comprising:
positioning an oxidant gas inlet connector and an oxidant gas outlet connector on the manifold of the fuel cell stack;
connecting an oxidant gas passage within the fuel cell stack to the oxidant gas inlet connector and the oxidant gas outlet connector;
connecting an oxidant gas inlet pipe to the oxidant gas inlet connector to supply an oxidant gas to the oxidant gas passage; and
connecting an oxidant gas outlet pipe to the oxidant gas outlet connector to discharge the oxidant gas from the fuel gas passage,
wherein positioning the oxidant gas outlet connector comprises positioning the oxidant gas outlet connector on the manifold of the fuel cell stack below a level of the oxidant gas passage within the fuel cell stack to enable fluid to be discharged from the oxidant gas outlet pipe.

27. The method of claim 26, wherein the oxidant gas passage comprises a plurality of oxidant gas passages within the fuel cell stack, the method further comprising connecting each of the oxidant gas passages to the oxidant gas inlet connector and the oxidant gas outlet connector.

28. The method of claim 26, further comprising:
installing a sensor within the oxidant gas inlet pipe substantially adjacent to the oxidant gas inlet connector positioned on the manifold of the fuel cell stack; and
installing another sensor within the oxidant gas outlet pipe substantially adjacent to the oxidant gas outlet connector positioned on the manifold of the fuel cell stack.

29. The method of claim 26, wherein the fuel cell stack comprises a set of fuel cell stacks layered in a direction of the gravitational force, the method further comprising connecting an oxidant gas passage within each of the set of fuel cell stacks to the oxidant gas inlet connector and the oxidant gas outlet connector positioned on the manifold of the set of fuel cell stacks.

30. The method of claim 18, further comprising:
positioning a fuel gas inlet connector and a fuel gas outlet connector on the manifold of the fuel cell stack; and
positioning an oxidant gas inlet connector and an oxidant gas outlet connector on the manifold of the fuel cell stack.

31. The method of claim 30, wherein positioning the connectors comprises positioning the connectors on the manifold of the fuel cell stack such that each of the connectors are not positioned directly above or below another one of the connectors.

32. The method of claim 30, wherein positioning the connectors comprises:
positioning the coolant fluid outlet connector and the oxidant gas outlet connector on one side of the manifold of the fuel cell stack; and
positioning the fuel gas outlet connector on another side of the manifold of the fuel cell stack.
